(19) United States
(12) Patent Application Publication
(10) Pub. No.: US 2025/0033516 A1
(43) Pub. Date: Jan. 30, 2025

(54) CHARGING PLAN CREATION SYSTEM, CHARGING PLAN CREATION METHOD, AND NON-TRANSITORY COMPUTER-READABLE RECORDING MEDIUM

(71) Applicant: Panasonic Intellectual Property Management Co., Ltd., Osaka (JP)

(72) Inventors: Tomokazu SADA, Nara (JP); Changhui YANG, Osaka (JP)

(21) Appl. No.: 18/713,798

(22) PCT Filed: Nov. 15, 2022
(86) PCT No.: PCT/JP2022/042368

§ 371 Date: May 28, 2024

(30) Foreign Application Priority Data
Nov. 29, 2021 (JP) 2021-192869

(51) Int. Cl. B60L 53/67; B60L 53/62; B60L 53/66; B60L 58/12

(52) U.S. Cl. CPC B60L 53/67; B60L 53/62; B60L 53/66; B60L 58/12

(57) ABSTRACT

A predicted distribution creation unit performs statistical processing on use histories of a plurality of battery packs used by being mounted on a moving body and creates a predicted distribution of the use amounts of the plurality of battery packs per day. A charging plan creation unit creates charging plans of the plurality of battery packs prepared for the operation of a target date on the basis of the created predicted distribution of the use amounts of the plurality of battery packs. The charging plan creation unit determines the distribution of charging end SOCs (State Of Charge) of the plurality of battery packs on the basis of the predicted distribution of the use amounts.

### CROSS-REFERENCE TO RELATED APPLICATIONS

This application is based upon and claims the benefit of priority from the prior Japanese Patent Application No. 2021-192869, filed on Nov. 29, 2021, and the International Patent Application No. PCT/JP2022/042368, filed on Nov. 15, 2022, the entire content of each of which is incorporated herein by reference.

### BACKGROUND

### Field of the Invention

The present disclosure relates to a charging plan creation system, a charging plan creation method, and a charging plan creation program for creating charging plans for a plurality of secondary batteries.

### Description of the Related Art

The use of electrically driven vehicles in commercial vehicles used by delivery operators and taxi operators is increasing. In businesses that use electrically driven vehicles, it is important to suppress the degradation of secondary batteries because extension of the life of secondary batteries installed in electrically driven vehicles greatly contributes to cost reduction.

As a method for creating a vehicle disposition plan that contributes to suppressing degradation of secondary batteries, a method for creating a plan has been proposed that takes into account vehicle-related information such as degradation status of secondary batteries, travel distance, number of travels, delivery time, vehicle power consumption, etc., and external variables such as the amount of cargo in an area where the vehicle is traveling, the distance traveled for delivery, travel time, etc. (see, for example, Patent Literature 1).

Patent Literature 1: JP 2021-86570

The above method is effective in a business type such as a delivery business where it is easy to estimate external variables such as delivery route, travel distance required for delivery, travel start time, etc. in advance. However, it is not suitable for businesses such as taxi and rental car businesses where it is difficult to estimate external variables such as travel distance and travel start time in advance. In such business types, it is difficult to plan the optimal charging and traveling conditions of each electrically driven vehicle that contribute to suppressing the degradation of secondary batteries.

### SUMMARY OF THE INVENTION

The present disclosure addresses the above-described issue, and a purpose thereof is to provide a technology for creating charging plans that contribute to suppressing degradation of secondary batteries used in business types where demand prediction is difficult.

In order to solve the aforementioned problems, a charging plan creation system according to one embodiment of the present disclosure is a charging plan creation system that creates charging plans for a plurality of battery packs managed by a business entity and includes: a predicted distribution creation unit that performs statistical processing on use histories of the plurality of battery packs used by being mounted on a moving body and that creates a predicted distribution of the use amounts of the plurality of battery packs per day; and a charging plan creation unit that creates charging plans for the plurality of battery packs prepared for operation on a target date on the basis of the created predicted distribution of the use amounts of the plurality of battery packs. The charging plan creation unit determines the distribution of charging end SOCs (State Of Charge) of the plurality of battery packs on the basis of the predicted distribution of the use amounts.

Optional combinations of the aforementioned constituting elements and implementations of the present disclosure in the form of apparatuses, systems, methods, programs, etc., may also be practiced as additional modes of the present disclosure.

Embodiments will now be described, by way of example only, with reference to the accompanying drawings which are meant to be exemplary, not limiting, and wherein like elements are numbered alike in several Figures, in which:

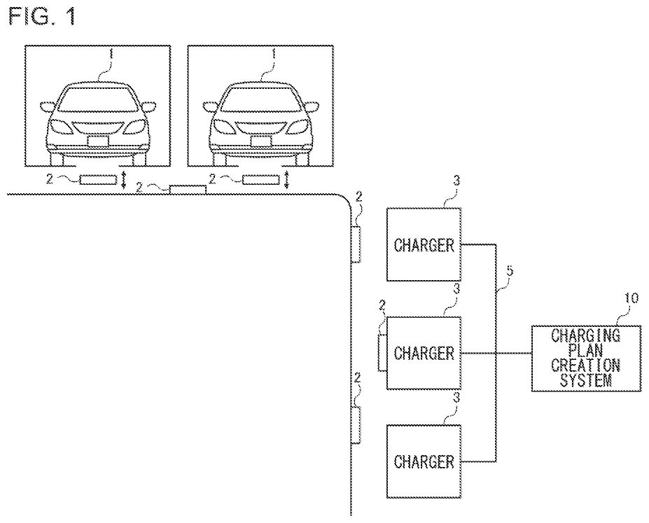

FIG. 1 is a diagram showing a schematic configuration of a battery replacement station in which a charging plan creation system according to an embodiment is used.

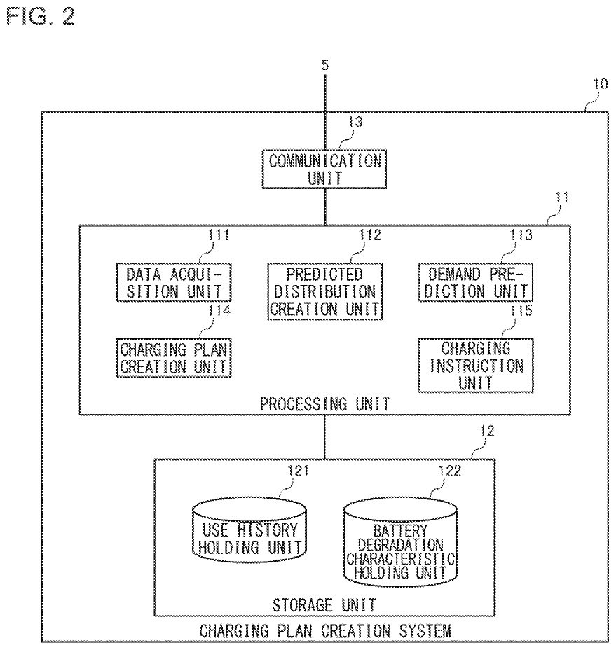

FIG. 2 is a diagram showing an example of the configuration of the charging plan creation system according to the embodiment.

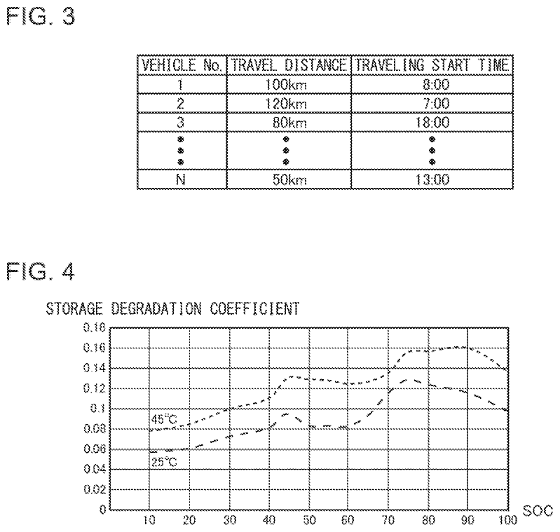

FIG. 3 is a diagram showing an example of use history data accumulated in a use history holding unit.

FIG. 4 is a diagram showing an example of a storage degradation characteristic map.

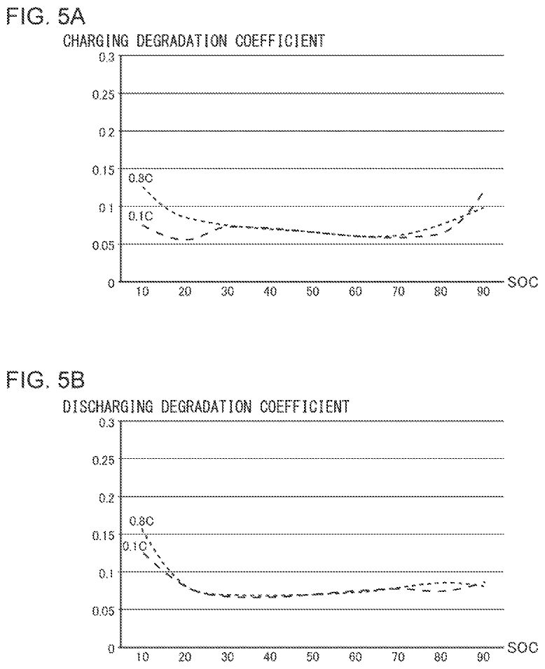

FIGS. 5A and 5B are diagrams each showing an example of a charging/discharging degradation characteristic map.

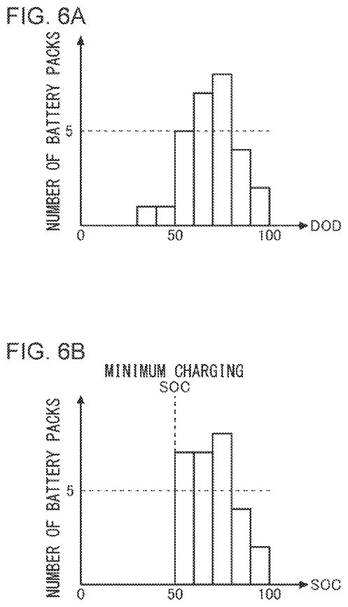

FIG. 6A is a diagram showing an example of a traveling DOD distribution that is based on statistical data.

FIG. 6B is a diagram showing an example of a charging end SOC distribution of a charging plan.

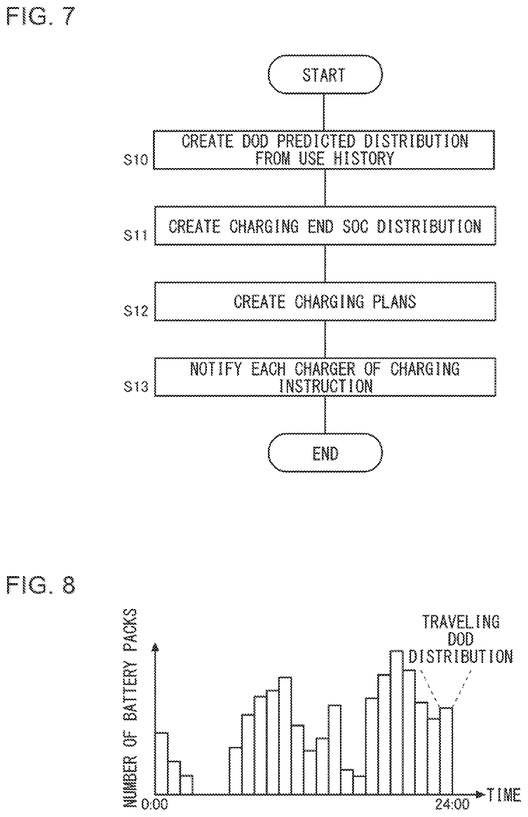

FIG. 7 is a flowchart showing the flow of a charging plan creation method according to the first exemplary embodiment.

FIG. 8 is a diagram showing an example of a traveling start time distribution.

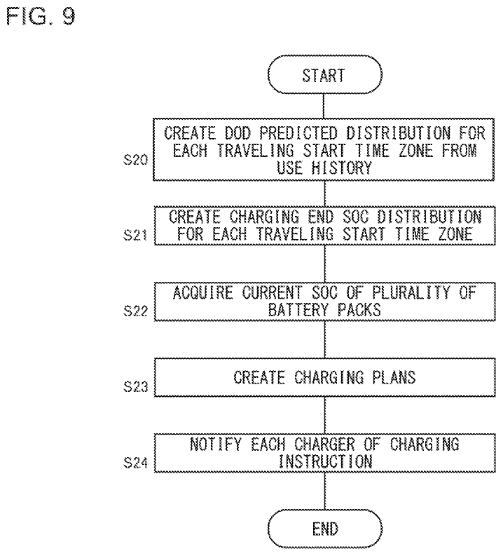

FIG. 9 is a flowchart showing the flow of a charging plan creation method according to the second exemplary embodiment.

### DETAILED DESCRIPTION OF THE INVENTION

The invention will now be described by reference to the preferred embodiments. This does not intend to limit the scope of the present invention, but to exemplify the invention.

FIG. 1 is a diagram showing a schematic configuration of a battery replacement station in which a charging plan creation system 10 according to an embodiment is used. The battery replacement station of the present embodiment is installed at a certain operating base of a taxi operator. The taxi operator manages and operates a plurality of electrically driven vehicles 1, a plurality of battery packs 2, and a plurality of battery chargers 3 at the operating base. The plurality of battery packs 2 are removable and replaceable battery packs, and the number of battery packs 2 that are provided is greater than the number of electrically driven vehicles 1.

The battery packs 2 are mounted on the bottom of the electrically driven vehicle 1. When the electrically driven vehicle 1 is parked at a predetermined place on a replacement table, a replacement device (not shown) installed under the replacement table removes the used battery pack 2 from the bottom of the electrically driven vehicle 1 and attaches a charged battery pack 2. A belt conveyor for transporting battery packs 2 is installed under the replacement table. The used battery pack 2 is transported by the belt conveyor to the position of a charger 3. A charged battery pack 2 that has been charged in the charger 3 is transported by the belt conveyor to the position of each replacement table. A battery pack 2 can be usually replaced in about five minutes for an electrically driven vehicle 1, allowing the vehicle to resume driving in about the same amount of time as it takes to refuel a gasoline vehicle.

Each charger 3 has at least one charging slot and charges a battery pack 2 when the battery pack 2 is installed. The charger 3 and the battery pack 2 may be connected by a charging cable.

A battery pack 2 includes a plurality of cells and a battery management unit (BMU). Inside the battery pack 2, the plurality of cells are configured by connecting a plurality of single cells or a plurality of parallel cell blocks (configured by a plurality of cells connected in parallel) in series. For the cells, lithium-ion battery cells, nickel hydrogen battery cells, lead battery cells, etc., can be used. Hereinafter, an example is assumed in the present specification where lithium-ion battery cells, with nominal voltage of 3.6-3.7 V, are used. The number of single cells or parallel cell blocks in series is determined according to the drive voltage of the motor installed in the electrically driven vehicle 1.

The battery management unit monitors and measures the voltage, current, temperature, and SOC of the plurality of cells included in the battery pack 2, and accumulates the data as use history data of the battery pack 2. For example, the battery management unit samples the voltage, current, and temperature of the plurality of cells periodically, e.g., at 10 second intervals.

The battery management unit combines the open circuit voltage (OCV) method and the current integration method so as to estimate the SOC. The OCV method is a method for estimating the SOC based on the OCV of the cell that is measured and the SOC-OCV curve of the cell. The current integration method is a method for estimating the SOC based on the OCV at the start of charging/discharging of a cell and the integrated value of the current that is measured. In the current integration method, current measurement errors accumulate as the charging/discharging time becomes longer. Therefore, the SOC estimated according to the current integration method is preferably corrected using the SOC estimated according to the OCV method.

The battery management unit may be configured so as to be able to acquire travel data from an electronic control unit (ECU) of the electrically driven vehicle 1. For example, as the travel data, travel distance, traveling start time, traveling end time, vehicle speed, motor rotating speed, rotating torque, inverter input voltage, input current, etc., can be acquired.

The charger 3 is connected to a commercial power system (not shown) and charges the battery pack 2. In general, the battery pack is charged with alternating current for normal charging and with direct current for quick charging. When charging is performed with alternating current, e.g., single-phase 100/200V, alternating current power is converted to direct current power by an AC/DC converter (not shown) in the battery pack 2. When the charging is performed with direct current, the charger 3 generates direct current power by rectifying alternating current power supplied from the commercial power system in full wave followed by smoothing with a filter.

For example, CHAdeMO (registered trademark), ChaoJi, GB/T, and Combined Charging System (Combo) can be used as quick charging standards. In CHAdeMO 2.0, the maximum output (specification) is defined as follows: 1000 V×400 A=400 kW. In CHAdeMO 3.0, the maximum output (specification) is defined as follows: 1500 V×600 A=900 kW. In ChaoJi, the maximum output (specification) is defined as follows: 1500 V×600 A=900 kW. In GB/T, the maximum output (specification) is defined as follows: 750 V×250 A=185 kw. In Combo, the maximum output (specification) is defined as follows: 900 V×400 A=350 kW. A controller area network (CAN) is employed as the communication method in CHAdeMO, ChaoJi, and GB/T. Power line telecommunication (PLC) is employed as a communication method in Combo.

The battery management unit of the battery pack 2 transmits use history data to the charger 3. The use history data includes battery data for the plurality of cells in the battery pack 2. If the battery management unit has acquired travel data from the ECU, the use history data also includes travel data.

The charging plan creation system 10 is a system for creating charging plans for a plurality of battery packs 2 managed by a business entity that operates the battery replacement station. The charging plan creation system 10 is built, for example, on a PC installed at an operating base where the battery replacement station is installed. The charging plan creation system 10 and the plurality of chargers 3 installed at the battery replacement station are connected by the network 5, e.g., wired/wireless LAN. Each charger 3 transmits use history data acquired from a battery pack 2 to the charging plan creation system 10 via the network 5.

FIG. 2 is a diagram showing an example of the configuration of the charging plan creation system 10 according to the embodiment. The charging plan creation system 10 includes a processing unit 11, a storage unit 12, and a communication unit 13. For example, the communication unit 13 is a communication interface that has an access point or router and that is for connecting to the network 5 by wire or wirelessly. If a router is installed, access to the Internet is also possible.

The processing unit 11 includes a data acquisition unit 111, a predicted distribution creation unit 112, a demand prediction unit 113, a charging plan creation unit 114, and a charging instruction unit 115. The function of the processing unit 11 can be realized by cooperation of hardware resources and software resources, or only by hardware resources. As the hardware resources, CPU, ROM, RAM, graphics processing unit (GPU), application specific integrated circuit (ASIC), field programmable gate array (FPGA), and other LSIs can be used. Programs such as operating systems and applications can be used as the software resources.

The storage unit 12 includes a non-volatile recording medium such as HDD, SSD, etc., and stores various types of data. The storage unit 12 includes a use history holding unit 121 and a battery degradation characteristic holding unit 122. The data acquisition unit 111 acquires use history data of each battery pack 2 from each charger 3 and stores the use history data in the use history holding unit 121.

FIG. 3 is a diagram showing an example of use history data accumulated in the use history holding unit 121. The use history data shown in FIG. 3 is data that records travel distance per day and traveling start time for a plurality of electrically driven vehicles 1 belonging to the above operating base. Although data of more items is actually recorded, FIG. 3 shows only the data related to charging plan creation according to the present embodiment.

If the battery pack 2 is not replaced in the middle of a day, the travel distance per day can be substituted by the difference between the SOC at the start of use and the SOC at the end of use (=DOD: Depth Of Discharge) of the battery pack 2 in the day. The traveling start time in a day can be substituted by the start time of discharge of the battery pack 2 in the day.

The battery degradation characteristic holding unit 122 holds a storage degradation characteristic map, a charging degradation characteristic map, and a discharging degradation characteristic map. The storage degradation of a secondary battery is degradation that progresses over time depending on the temperature of the secondary battery at each point of time and the SOC at each point of time. The storage degradation progresses regardless of whether or not the secondary battery is being charged or discharged. The storage degradation mainly occurs due to the formation of a coating film (solid electrolyte interphase (SEI) film) on the negative electrode. The storage degradation depends on the SOC and the temperature at each point of time. Generally, the higher the SOC at each point of time and the higher the temperature at each point of time, the higher the degradation speed.

The charging and discharging degradation of a secondary battery is degradation that progresses as the number of times of charging and discharging increases. Charging and discharging degradation occurs mainly due to cracking, peeling, or the like caused due to expansion or contraction of active materials. The charging and discharging degradation depends on the SOC range that is used, the temperature, and a current rate. In general, the wider the SOC range that is used, the higher the temperature, and the higher the current rate, the higher the charging and discharging degradation rate.

The storage degradation characteristic, the charging degradation characteristic, and the discharging degradation characteristic are derived in advance for each secondary battery type through experiments and simulations performed by battery manufacturers.

FIG. 4 is a diagram showing an example of a storage degradation characteristic map. The horizontal axis shows SOC [%], and the vertical axis shows a storage degradation coefficient corresponding to the storage degradation speed. In general, storage degradation progresses approximately linearly with respect to a value obtained by raising elapsed time (h) to the power of 0.5 (square root). Depending on the type of secondary battery, there are secondary batteries where storage degradation progress approximately linearly with respect to a value obtained by raising the elapsed time (h) to the power of 0.4,a value obtained by raising the elapsed time (h) to the power of 0.6, or the like.

For the purpose of simplification, FIG. 4 only depicts the storage degradation characteristics for two temperatures, which are 25 degrees Celsius and 45 degrees Celsius. In reality, however, storage degradation characteristics are generated for a large number of temperatures. The storage degradation characteristics may be defined not as a map but as a storage degradation characteristic model (function) with SOC and a temperature as explanatory variables and the storage degradation coefficient as an objective variable.

FIGS. 5A and 5B are diagrams each showing an example of a charging/discharging degradation characteristic map. FIG. 5A shows an example of a charging degradation characteristic map and FIG. 5B shows an example of a discharging degradation characteristic map. The horizontal axis indicates the usage range of SOC [%]. In FIGS. 5A to 5B, each SOC value indicates the lower limit of a 10% usage range. For example, 10% SOC indicates that the SOC is charged and discharged in the range of 10 to 20%, and 11% SOC indicates that the SOC is charged and discharged in the range of 11 to 21%. The vertical axis shows a charging/discharging degradation coefficient corresponding to charging/discharging degradation speed.

In general, charging degradation or discharging degradation progresses approximately linearly with respect to a value obtained by raising the total charging amount (Ah) or total discharging amount (Ah) to the power of 0.5 (square root). Depending on the type of secondary battery, there are secondary batteries where charging degradation or discharging degradation progresses approximately linearly with respect to a value obtained by raising the total charging amount (Ah) or total discharging amount (Ah) to the power of 0.4 or to the power of 0.6, or the like.

For the purpose of simplification, FIG. 5A to 5B only depict the charging/discharging degradation characteristics for two current rates, 0.1 C and 0.8 C. However, in reality, charging/discharging degradation characteristics are generated for a large number of current rates. As shown in FIG. 5A, it can be seen that the charging/discharging degradation speed increases in low and high SOC usage range regions at the time of charging. As shown in FIG. 5B, it can be seen that the charging/discharging degradation speed increases in a low SOC usage range region at the time of discharging.

Further, the charging/discharging degradation characteristic is also affected by temperature, although the temperature does not contribute as much as the current rate. Therefore, in order to increase the estimation accuracy of the charging/discharging degradation speed, it is preferable to prepare charging/discharging degradation characteristics that define the relationship between the SOC usage range and the charging/discharging degradation coefficient for each two-dimensional combination of a plurality of current rates and a plurality of temperatures. On the other hand, when generating a simplified charging/discharging degradation characteristic map, the temperature is considered to be room temperature, and it is sufficient to prepare a charging/discharging degradation characteristic for each of the plurality of current rates.

The charging/discharging degradation characteristics may be defined not as a map but as a charging/discharging degradation characteristic model (function) with a SOC usage range, a current rate, and a temperature as explanatory variables and the charging/discharging degradation coefficients as objective variables. The temperature may be a constant.

An explanation will be given in the following regarding a charging plan creation method according to the first exemplary embodiment that is performed by the charging plan creation system 10. In the first exemplary embodiment, when charging a plurality of battery packs 2 belonging to the above operating base that are prepared for the operation on a certain business day, which is hereinafter referred to as “target date”, the plurality of battery packs 2 are charged such that the charging end SOCs of the plurality of battery packs 2 are statistically optimally distributed instead of charging all the battery packs 2 to full charge.

In FIG. 2, the predicted distribution creation unit 112 performs statistical processing on the use histories of the plurality of battery packs 2 accumulated in the use history holding unit 121 and creates a predicted distribution of the use amounts of the plurality of battery packs 2 for a target date. The charging plan creation unit 114 creates charging plans of the plurality of battery packs prepared for the operation on the target date on the basis of the created predicted distribution of the use amounts of the plurality of battery packs 2. Hereinafter, the use amounts of the battery packs 2 per day are considered in DOD.

FIG. 6 is a diagram showing an example of a traveling DOD distribution that is based on statistical data and a charging end SOC distribution of a charging plan. FIG. 6A shows an example of a traveling DOD distribution that is based on statistical data, and FIG. 6B shows an example of a charging end SOC distribution of a charging plan. The predicted distribution creation unit 112 extracts the travel distance of each electrically driven vehicle 1 for each day that is accumulated in the use history holding unit 121, and converts each extracted travel distance into the DOD used for the traveling.

The predicted distribution creation unit 112 can, for example, estimate an electricity consumption amount due to traveling for a day by multiplying the electric cost of each battery pack 2 by the travel distance per day, and estimate the DOD of each battery pack 2 per day based on the estimated electricity consumption amount and the full charge capacity of each battery pack 2. If the SOC at the start of use and the SOC at the end of use of the battery packs 2 per day are recorded in the use history holding unit 121, the DOD for the day can be estimated from the difference between the two.

The predicted distribution creation unit 112 creates a traveling DOD distribution by averaging the DOD of the plurality of battery packs 2 per day over the entire past period or a specific period. The traveling DOD distribution shown in FIG. 6A shows one battery pack 2 for DOD of 30 to 40%, one battery pack 2 for DOD of 40 to 50%, five battery packs 2 for DOD of 50 to 60%, seven battery packs 2 for DOD of 60 to 70%, eight battery packs 2 for DOD of 70 to 80%, four battery packs 2 for DOD of 80 to 90%, and two battery packs 2 for DOD of 90 to 100%.

The charging plan creation unit 114 determines the distribution of the charging end SOCs for the plurality of battery packs 2 based on the predicted distribution of traveling DOD that is based on past data created by the predicted distribution creation unit 112. The charging plan creation unit 114 basically determines the distribution of the charging end SOCs of the plurality of battery packs 2 such that the distribution corresponds to the created predicted distribution of traveling DOD.

The charging end SOC distribution shown in FIG. 6B shows seven battery packs 2 for a charging end SOC of 60%, seven battery packs 2 for a charging end SOC of 70%, eight battery packs 2 for a charging end SOC of 80%, four battery packs 2 for a charging end SOC of 90%, and two battery packs 2 for a charging end SOC of 100%. An example shown in FIG. 6B shows one battery pack 2 for DOD of 30 to 40%, one battery pack 2 for DOD of 40 to 50%, and five battery packs 2 for DOD of 50 to 60% are grouped together as seven battery packs 2 for DOD of 50 to 60% since the minimum charging SOC is set to 60%.

In the charging plan, the charging plan creation unit 114 preferentially assigns a battery pack 2 with a high SOH (State Of Health) to a battery pack 2 with a high charging end SOC among the plurality of battery packs 2 in a charging plan.

SOH is defined by the ratio of the current FCC to the initial FCC (Full Charge Capacity), and the lower the value thereof (the closer to 0%) is, the more the degradation is progressing. The SOH is normally estimated by the following method. The difference in SOC at the start of charging and SOC at the end of charging is calculated, and the FCC is obtained by dividing the integrated value of charging current by the difference in SOC. The SOH is then estimated by dividing the obtained FCC by the initial FCC. The SOH may be estimated by the processing unit 11 of the charging plan creation system 10 or by the battery management unit in the battery pack 2.

For example, the charging plan creation unit 114 assigns battery packs 2 in descending order of SOH to those in descending order of charging end SOC. As the DOD becomes larger, the load on the battery pack 2 becomes larger. Thus, battery packs 2 in which degradation is progressing are assigned to battery packs 2 whose DOD is planned to be small. This allows for a reduction in the load on the battery packs 2 with progressed degradation and prevention of the battery packs 2 with progressed degradation from degrading rapidly.

The predicted distribution creation unit 112 may narrow the range of data to be the basis of the traveling DOD distribution according to the attribute of the target date. For example, if the target date is a weekend or a holiday, the predicted distribution creation unit 112 creates a traveling DOD distribution using only data for weekends and holidays out of the use history of the plurality of battery packs 2 accumulated in the use history holding unit 121. Further, if the target date is a weekday, the predicted distribution creation unit 112 creates a traveling DOD distribution using only data for weekdays out of the use history of the plurality of battery packs 2 accumulated in the use history holding unit 121.

Further, the predicted distribution creation unit 112 may create a traveling DOD distribution for each day of a week using only data for each day of a week out of the use history of the plurality of battery packs 2 accumulated in the use history holding unit 121. Further, the predicted distribution creation unit 112 may create traveling DOD distributions for spring, summer, fall, and winter using only data for each season out of the use history of the plurality of battery packs 2 accumulated in the use history holding unit 121. Further, the predicted distribution creation unit 112 may create traveling DOD distributions for sunny weather, cloudy weather, rainy weather, and snow weather using only data for each weather out of the use history of the plurality of battery packs 2 accumulated in the use history holding unit 121. The past weather information near the operating base may be acquired from a weather information site on the Internet.

The demand prediction unit 113 can create a correction factor α based on demand prediction for the target date. For example, if a large-scale event, e.g., a sporting event or concert, is held near the operating base on the target date, the demand prediction unit 113 generates a correction factor α (α>1) of a large value. The predicted distribution creation unit 112 corrects the traveling DOD distribution based on the correction factor α that is based on the demand prediction created by the demand prediction unit 113. For example, the predicted distribution creation unit 112 multiplies each DOD by the correction factor α (the upper limit of DOD is 100%) to bring the entire traveling DOD distribution closer to 100%. For example, if a large-scale event is being held, the correction factor α may be set to 10, and all the battery packs 2 may be charged to full capacity.

The demand prediction unit 113 may generate a demand prediction model for deriving the correction factor α for the basic distribution of traveling DOD by performing multiple regression analysis of multiple factors, e.g., weather, day of the week, economic indicators, etc., that are relevant to the demand prediction. The demand prediction unit 113 may input factors such as weather forecast information for the business day into the demand prediction model so as to derive the correction factor α.

The charging instruction unit 115 notifies each charger 3 via the network 5 of a charging instruction based on a charging plan created by the charging plan creation unit 114. In the first exemplary embodiment, the charging instruction to each charger 3 includes at least the charging end SOC of a battery pack 2 to be charged. FIG. 7 is a flowchart showing the flow of a charging plan creation method according to the first exemplary embodiment. The predicted distribution creation unit 112 creates a statistical DOD predicted distribution from the use history of the plurality of battery packs 2 (S10). In creating this DOD predicted distribution, the demand prediction predicted by the demand prediction unit 113 may be taken into account. The charging plan creation unit 114 creates a charging end SOC distribution of the plurality of battery packs 2 based on the created DOD predicted distribution (S11). The charging plan creation unit 114 creates charging plans for the plurality of battery packs 2 based on the charging end SOC distribution (S12). The charging instruction unit 115 notifies each charger 3 of a charging instruction based on the created charging plan (S13).

Next, an explanation will be given in the following regarding a charging plan creation method according to the second exemplary embodiment that is performed by the charging plan creation system 10. In the second exemplary embodiment, when charging a plurality of battery packs 2 belonging to the above operating base that are prepared for the operation on a target date, a traveling start time distribution is taken into consideration in addition to the traveling DOD distribution shown in the first exemplary embodiment. This optimizes the charging start time, the charging end time, and the charge rate in addition to the charging end SOC of the plurality of battery packs 2.

The predicted distribution creation unit 112 performs statistical processing on the use histories of the plurality of battery packs 2 accumulated in the use history holding unit 121 and creates a predicted distribution of the use amounts of the plurality of battery packs 2 for each usage start time zone for a target date. The charging plan creation unit 114 creates charging plans of the plurality of battery packs 2 prepared for the operation on the target date based on the created predicted distribution of the use amounts of the plurality of battery packs 2 for each usage start time zone, on the current SOCs of the plurality of battery packs, and on the current time.

FIG. 8 is a diagram showing an example of a traveling start time distribution. The traveling start time of each electrically driven vehicle 1 depends on a pick-up request from a customer, the driver's judgment, and the like. The predicted distribution creation unit 112 extracts the traveling start time of each electrically driven vehicle 1 for each day that is accumulated in the use history holding unit 121. The predicted distribution creation unit 112 creates a traveling start time distribution by averaging the traveling start times of a plurality of electrically driven vehicles 1 for each time zone, e.g., one hour increment, over the entire past period or a specific period. The predicted distribution creation unit 112 creates a traveling DOD distribution for each traveling start time zone.

Thereby, the charging plan creation unit 114 can determine the number of charged battery packs 2 to be prepared at each time, 0:00, 1:00, . . . , 23:00, and the charging end SOC distribution of each of the battery packs 2 to be prepared. In order to suppress storage degradation, it is desirable to charge the batteries such that the charging end SOC is reached as close as possible to the traveling start time. Further, in order to suppress charging degradation, charging is desirable performed at a charge rate as low as possible.

Based on a predetermined charging plan creation model, the charging plan creation unit 114 outputs the charging start time, the charging end time, and the charging rate pattern of each battery pack 2 that minimizes the sum of the storage degradation and charging degradation of the plurality of battery packs 2. The charging plan creation model is a model that uses the current time, the charging end time, the current SOCs of the plurality of battery packs 2, and the charging end SOCs of the plurality of battery packs 2 as input, and that outputs the charging start time, charging end time, and charging rate pattern of each battery pack 2 that minimizes the sum of the storage degradation and charging degradation of the plurality of battery packs 2.

When creating the charging plan creation model, the storage degradation characteristic and charge degradation characteristic of each battery pack 2 are incorporated. The charging method may be a fixed model of CCCV charging, or a variable model in which the charging rate can be changed for each time zone. The number of battery packs 2 belonging to the battery replacement station and the total number of charging ports at the battery replacement station are fixed values.

The charging plan creation model may incorporate an algorithm such as the one in the following. The charging plan creation algorithm sets a plurality of nodes in an SOC section between a charging end SOC and a current SOC, sets a plurality of nodes within a chargeable time between a charging start time and a charging end time, and searches for a charging path to be reached via a plurality of nodes from the current SOC at the charging start time to the charging end SOC at the charging end time. On the basis of an SOC and a charging rate at each point, the charging plan creation algorithm assigns the amount of degradation to a path between each node with reference to the storage degradation characteristics and the charge degradation characteristics. The charging plan creation algorithm searches for a charging path that minimizes the sum of the amounts of degradation of paths between nodes.

The charging start time is restricted to be set after the current time. The charging end time is set to be the traveling start time determined based on the traveling start time distribution. The charging rate is constrained by the need to perform charging from the current SOC to the charging end SOC within the chargeable time between the charging start time and the charging end time. The charging plan creation model may be updated by learning based on actual operation data. Further, in the charging plan creation model, an expected temperature at a scheduled charging time zone may be taken into consideration.

The charging instruction unit 115 notifies each charger 3 via the network 5 of a charging instruction based on a charging plan created by the charging plan creation unit 114. In the second exemplary embodiment, a charging instruction to each charger 3 includes a charging start time, a charging end time, a charging rate pattern, and a charging end SOC.

FIG. 9 is a flowchart showing the flow of a charging plan creation method according to the second exemplary embodiment. The predicted distribution creation unit 112 creates a statistical DOD predicted distribution for each traveling start time zone from the use history of the plurality of battery packs 2 (S20). In creating this DOD predicted distribution, the demand prediction predicted by the demand prediction unit 113 may be taken into account. The charging plan creation unit 114 creates a charging end SOC distribution of the plurality of battery packs 2 for each traveling start time zone on the basis of the created DOD predicted distribution for each traveling start time zone (S21). The charging plan creation unit 114 acquires the current SOC of the plurality of battery packs 2 (S22). The charging plan creation unit 114 creates charging plans for the plurality of battery packs 2 on the basis of the charging end SOC distribution, the current SOCs of the plurality of battery packs, and the current time (S23). The charging instruction unit 115 notifies each charger 3 of a charging instruction based on the created charging plan (S24).

As described above, according to the present embodiment, even in a business category where it is difficult to predict the demand of each electrically driven vehicle 1, it is possible to suppress battery degradation in the plurality of battery packs 2 as a whole at the operating base by creating a statistical distribution on the basis of the past traveling history at the operating base as a whole. In the first exemplary embodiment, it is possible to optimize the suppression of storage degradation of the plurality of battery packs 2 at the operating base as a whole by determining the charging end SOC distribution of the charging plan on the basis of the traveling DOD predicted distribution. That is, by reducing the number of battery packs 2 that are charged more than necessary, it is possible to reduce the time spent waiting in a high SOC state, and it is possible to suppress the wasteful progress of storage degradation. Further, by correcting the charging end SOC distribution in the charging plan based on the day of the week, event prediction, or the like, it is possible to optimize the capture of customer demand and the suppression of storage degradation.

In the second exemplary embodiment, by taking into consideration the traveling start time, it is possible to optimize the charging plan including the charging timing and the charging rate. Thereby, it is possible to optimize the suppression of storage degradation and the suppression of charging degradation of the plurality of battery packs 2 as a whole at the operating base.

Described above is an explanation based on the embodiments of the present disclosure. The embodiments are intended to be illustrative only, and it will be obvious to those skilled in the art that various modifications to constituting elements and processes could be developed and that such modifications are also within the scope of the present disclosure.

In the above embodiment, an example is explained in which the charging plan creation system 10 creates charging plans for a plurality of battery packs 2 belonging to one operating base. In this regard, if a single business entity has a plurality of operating bases, the charging plan creation system 10 may create charging plans for the plurality of battery packs 2 existing at the plurality of operating bases as a whole. If the distance between the operating bases is short, it is possible to suppress battery degradation for a plurality of battery packs 2 belonging to the business entity as a whole by interchanging the battery packs 2.

In this example, the charging plan creation system 10 may be built on a cloud server, on an in-house server in a data center, or on a rental server. Further, use history data may be aggregated on a PC or server of one operating base, and a charging plan may be created on the PC or server of the operating base.

Four-wheeled electric vehicles are assumed as electrically driven vehicles 1 in the above embodiment. In this regard, electric motorcycles (electric scooters), electric bicycles, and electric kick scooters may also be used. Further, the electrically driven vehicles include not only full-standard electric vehicles but also low-speed electric vehicles such as golf carts and land cars. Further, targets on which a battery pack 2 is to be mounted are not limited to electrically driven vehicles 1. The targets on which a battery pack 2 is to be mounted include electric ships, railway vehicles, and electric mobile objects such as multicopters (drones).

Further, the charging plan creation system 10 according to the above embodiment can also be used for a rental service of battery packs 2 for a portable device, which is the concept included in a mobile object in the present specification, that uses a detachable battery pack 2. For example, the charging plan creation system 10 can be used for a rental service for battery packs 2 for laptop PCs.

In the above embodiment, an example of using a detachable replaceable battery packs 2 is assumed. Alternatively, charging plans created by the charging plan creation system 10 according to the present embodiment can also be applied to battery packs 2 fixedly attached to electrically driven vehicles 1 instead of replaceable battery packs 2.

The embodiment may be specified by the following items.

### Item 1

A charging plan creation system (10) that creates charging plans for a plurality of battery packs (2) managed by a business entity, comprising:
a predicted distribution creation unit (112) that performs statistical processing on use histories of the plurality of battery packs (2) used by being mounted on a moving body (1) and that creates a predicted distribution of the use amounts of the plurality of battery packs per day; and
a charging plan creation unit (114) that creates charging plans for the plurality of battery packs (2) prepared for operation on a target date on the basis of the created predicted distribution of the use amounts of the plurality of battery packs (2),
wherein the charging plan creation unit (114) determines the distribution of charging end SOCs (State Of Charge) of the plurality of battery packs (2) on the basis of the predicted distribution of the use amounts.

This allows for creation of charging plans that contribute to suppressing battery degradation of the plurality of battery packs (2) as a whole.

### Item 2

The charging plan creation system (10) according to Item 1,
wherein the charging plan creation unit (114) preferentially assigns a battery pack (2) with a high SOH (State Of Health) to a battery pack (2) with a high charging end SOC in the charging plan among the plurality of battery packs (2).

This allows for elongation of the lifetime of the plurality of battery packs (2) as a whole.

### Item 3

The charging plan creation system (10) according to Item 1 or 2,
wherein the predicted distribution creation unit (112) corrects the predicted distribution of the use amounts of the plurality of battery packs (2) based on demand prediction for the target date.

According to this, it is possible to optimize the capture of customer demand and the suppression of storage degradation.

### Item 4

The charging plan creation system (10) according to any one of Items 1 through 3,
wherein the use histories of the plurality of battery packs (2) include usage start times of the plurality of battery packs (2),
wherein the predicted distribution creation unit (112) creates a predicted distribution of the use amounts of the plurality of battery packs (2) for each usage start time zone for the target date, and
wherein the charging plan creation unit (114) creates charging plans for the plurality of battery packs (2) prepared for the operation on the target date on the basis of the created predicted distribution of the use amounts of the plurality of battery packs (2) for each usage start time zone, on the current SOCs of the plurality of battery packs (2), and on the current time.

This allows for suppression of storage degradation and charging degradation of the plurality of battery packs (2) as a whole.

### Item 5

The charging plan creation system (10) according to Item 1,
wherein the charging plan creation unit (114) determines a charging start time, a charging end time, and a charging rate pattern of the battery packs (2) such that degradation of the plurality of battery packs (2) as a whole is minimized.

This allows for minimization of storage degradation and charging degradation of the plurality of battery packs (2) as a whole.

### Item 6

A charging plan creation method for creating charging plans for a plurality of battery packs (2) managed by a business entity, comprising:
performing statistical processing on use histories of the plurality of battery packs (2) used by being mounted on a moving body (1) and creating a predicted distribution of the use amounts of the plurality of battery packs per day; and
creating charging plans for the plurality of battery packs (2) prepared for operation on a target date on the basis of the created predicted distribution of the use amounts of the plurality of battery packs (2),
wherein the distribution of charging end SOCs of the plurality of battery packs (2) is determined on the basis of the predicted distribution of the use amounts in the creating charging plans.

This allows for creation of charging plans that contribute to suppressing battery degradation of the plurality of battery packs (2) as a whole.

### Item 7

A charging plan creation program for creating charging plans for a plurality of battery packs (2) managed by a business entity, comprising computer-implemented modules including:
a module that performs statistical processing on use histories of the plurality of battery packs (2) used by being mounted on a moving body (1) and that creates a predicted distribution of the use amounts of the plurality of battery packs (2) per day; and
a module that creates charging plans for the plurality of battery packs (2) prepared for operation on a target date on the basis of the created predicted distribution of the use amounts of the plurality of battery packs (2),
wherein the module that creates the charging plans determines the distribution of charging end SOCs of the plurality of battery packs (2) on the basis of the predicted distribution of the use amounts.

This allows for creation of charging plans that contribute to suppressing battery degradation of the plurality of battery packs (2) as a whole.

1. A charging plan creation system that creates charging plans for a plurality of battery packs managed by a business entity, comprising:
a predicted distribution creation unit that performs statistical processing on use histories of the plurality of battery packs used by being mounted on a moving body and that creates a predicted distribution of the use amounts of the plurality of battery packs per day; and
a charging plan creation unit that creates charging plans for the plurality of battery packs prepared for operation on a target date on the basis of the created predicted distribution of the use amounts of the plurality of battery packs,
wherein the charging plan creation unit determines the distribution of charging end SOCs (State Of Charge) of the plurality of battery packs on the basis of the predicted distribution of the use amounts.

2. The charging plan creation system according to claim 1,
wherein the charging plan creation unit preferentially assigns a battery pack with a high SOH (State Of Health) to a battery pack with a high charging end SOC in the charging plan among the plurality of battery packs.

3. The charging plan creation system according to claim 1,
wherein the predicted distribution creation unit corrects the predicted distribution of the use amounts of the plurality of battery packs based on demand prediction for the target date.

4. The charging plan creation system according to claim 1,
wherein the use histories of the plurality of battery packs include usage start times of the plurality of battery packs,
wherein the predicted distribution creation unit creates a predicted distribution of the use amounts of the plurality of battery packs for each usage start time zone for the target date, and
wherein the charging plan creation unit creates charging plans for the plurality of battery packs prepared for the operation on the target date on the basis of the created predicted distribution of the use amounts of the plurality of battery packs for each usage start time zone, on the current SOCs of the plurality of battery packs, and on the current time.

5. The charging plan creation system according to claim 4,
wherein the charging plan creation unit determines a charging start time, a charging end time, and a charging rate pattern of the battery packs such that degradation of the plurality of battery packs as a whole is minimized.

6. A charging plan creation method for creating charging plans for a plurality of battery packs managed by a business entity, comprising:
performing statistical processing on use histories of the plurality of battery packs used by being mounted on a moving body and creating a predicted distribution of the use amounts of the plurality of battery packs per day; and
creating charging plans for the plurality of battery packs prepared for operation on a target date on the basis of the created predicted distribution of the use amounts of the plurality of battery packs,
wherein the distribution of charging end SOCs of the plurality of battery packs is determined on the basis of the predicted distribution of the use amounts in the creating charging plans.

7. A non-transitory computer-readable recording medium having embodied thereon a charging plan creation program for creating charging plans for a plurality of battery packs managed by a business entity, comprising computer-implemented modules including:
a module that performs statistical processing on use histories of the plurality of battery packs used by being mounted on a moving body and that creates a predicted distribution of the use amounts of the plurality of battery packs per day;
a module that creates charging plans for the plurality of battery packs prepared for operation on a target date on the basis of the created predicted distribution of the use amounts of the plurality of battery packs,
wherein the module that creates the charging plans determines the distribution of charging end SOCs of the plurality of battery packs on the basis of the predicted distribution of the use amounts.
